(19) United States
(12) Patent Application Publication
(10) Pub. No.: US 2021/0247321 A1
(43) Pub. Date: Aug. 12, 2021

(54) Screening Test Paper Reading System

(71) Applicant: Cheng-Hao KO, Hsinchu County (TW)

(72) Inventor: Cheng-Hao KO, Hsinchu County (TW)

(21) Appl. No.: 17/263,550

(22) PCT Filed: Feb. 15, 2019
(86) PCT No.: PCT/CN2019/075156

§ 371 Date: Jan. 27, 2021

(51) Int. Cl. G01N 21/78

(52) U.S. Cl. CPC G01N 21/78

(57) ABSTRACT

The invention discloses a screening test paper reading system, including a reading detection and light illumination unit having a reading detection device and a light illumination device; a screening test paper having a reaction zone arranged thereon, which is able to react chemically with a number of particular specimens and change its color accordingly; a test paper carrier having a bearing groove arranged thereon, which is for accommodating the screen test paper while the screen test paper is fixed onto the test paper carrier, and a linking member also arranged on the test paper carrier; a delivery unit having a driving device and a carrier base; the driving device is activated and moves the test paper carrier through the linking member, and the test paper carrier moves to a reading detection location on the reading detection.

### BACKGROUND OF THE PRESENT INVENTION

### Field of Invention

This invention generally relates to a screening test paper reading system, especially to a screening test paper reading system capable of achieving effects of fast screening and re-screening as well.

### Description of Related Arts

As people pay more and more attention to their health, screening, including physical screening or environmental screening, has become an extremely hot topic. FIG. 1 is a schematic view of a conventional screening test paper, wherein a reaction zone 11 is provided with on the screening test paper 10. When a user drops a specimen on the reaction zone 11, the reaction zone 11 reacts chemically with the specimen and the color of the reaction zone 11 changes accordingly. The user therefore is able to determine whether the specimen falls within the normal range based on the color change and the degree of the color contrast. However, the accuracy on determining color change observed by human's eyes is poor; hence, a precision screening through spectrum analyzer is often required.

Notably, when using a spectrum analyzer for screening, users have to place a screening test paper on a corresponding position manually so as to enable the spectrum analyzer to retrieve a color signal from the reaction zone. Unfortunately manual operations may cause the screening test paper wearing and lead easily to a problem that the color signal cannot be retrieved due to the inaccurate placement. Consequently, it is time-consuming in adjusting the position of the screening test paper. Therefore, it is far from being practical.

### SUMMARY OF THE PRESENT INVENTION

One object of the invention is to provide a screening test paper reading system, which is capable of achieving effects of conducting a fast screening and re-screening as well.

With the above object in view, one embodiment in the invention discloses a screening test paper reading system comprising: a reading detection and light illumination unit having a reading detection device and a light illumination device; a screening test paper having a reaction zone arranged thereon, which reacts chemically with a number of particular specimens and changes color accordingly; a test paper carrier having a bearing groove arranged thereon for accommodating the screen test paper, wherein the screen test paper is fixed onto the test paper carrier, and a linking member arranged on the test paper carrier; and a delivery unit having a driving device and a carrier base, wherein when the test paper carrier is placed into the carrier base on the delivery unit, the driving device is activated and moves the test paper carrier through the linking member, and when the test paper carrier moves to the reading detection location on the reading detection and light illumination unit, the light illumination device irradiates light source onto the screening test paper, and the reading detection device will read the reflected spectrum reflected after the light is irradiated by the light source on the reaction zone, thereby enabling the reading detection device to retrieve spectrum signals from each of the reaction zone for computing and analyzing of the spectrum signals.

According to the aforementioned screening test paper reading system, the delivery unit further comprises a caging device for locating a relative position between the test paper carrier and the reading detection device.

According to the aforementioned screening test paper reading system, the driving device is a stepping motor.

According to the aforementioned screening test paper reading system, the linking member is a rack.

According to the aforementioned screening test paper reading system, the screening test paper is for particular specimens selected from the group consisting of saliva, urine, blood, excrement, water, food, toxic and hazardous substance, microorganism, and combinations thereof.

According to the aforementioned screening test paper reading system, the light illumination device is selected from the group consisting of white LEDs, UV LEDs, NIR LEDs, laser diodes, halogen lamps, tungsten lamps, and combinations thereof.

According to the aforementioned screening test paper reading system, the reading detection device is an optical wavelength spectrometer or a spectrum analyzer.

According to the aforementioned screening test paper reading system, the screening test paper further includes a positioning part, which is provided for the use of fine-tune positioning operated by the reading detection and light illumination unit.

According to the aforementioned screening test paper reading system, the caging device further includes an opening with a “C”, “squared C” or “L” form to limit the test paper carrier when moved, so that the test paper carrier will not shift or detach from the base thereof.

According to the aforementioned screening test paper reading system, two ends of the rack are in circular-arc-shape.

### BRIEF DESCRIPTION OF THE DRAWINGS

FIG. 1 is a schematic view of a conventional screening test paper.

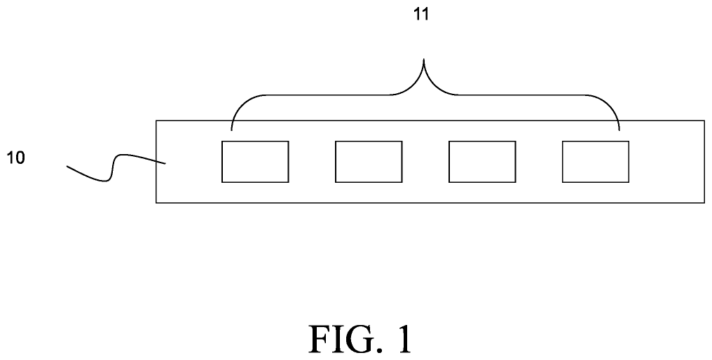

FIG. 2 is a 3D structural view of the screening test paper reading system according to the present invention.

FIG. 3 is a structural breakdown view of the screening test paper reading system according to the present invention.

FIG. 4 is a partial enlargement view of the test paper carrier according to the present invention.

FIG. 5 is a schematic view of the screening test paper according to the present invention.

FIG. 6 is a chart of the caging device running a position reading in the screening test paper reading system according to the present invention.

FIG. 7 is the reading position and relative positioning chart of the screening test paper reading system according to the present invention.

FIG. 8 is a reading position chart in the screening test paper reading system according to the present invention.

### DETAILED DESCRIPTION OF THE PREFERRED EMBODIMENT

Some terms are used to refer to specific components in the specification and subsequent claims. However, it is to be understood by a person having ordinary skill in the art that the hardware manufacturers may use different terms to describe the same component. The components in the specification and subsequent claims are not distinguished by their names, but by the difference in the function. The term “comprising” throughout the specification and subsequent claims is an open-ended term, so the term “comprising” is to be construed as “comprising, but not limited to”.

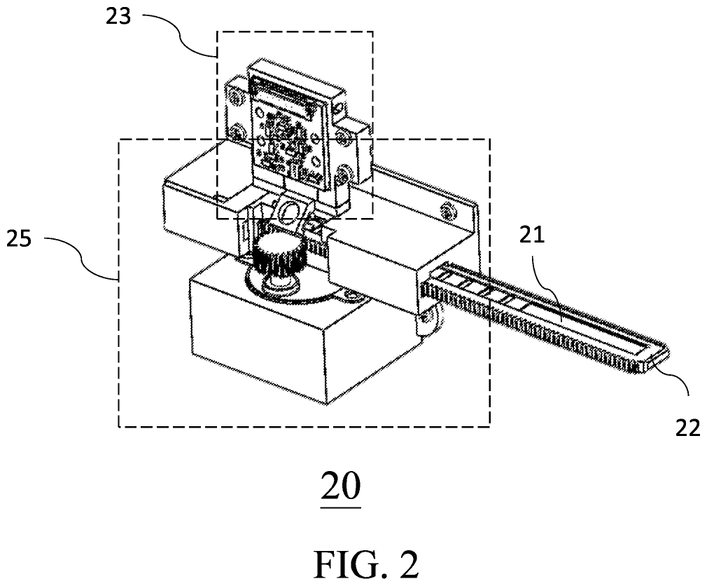

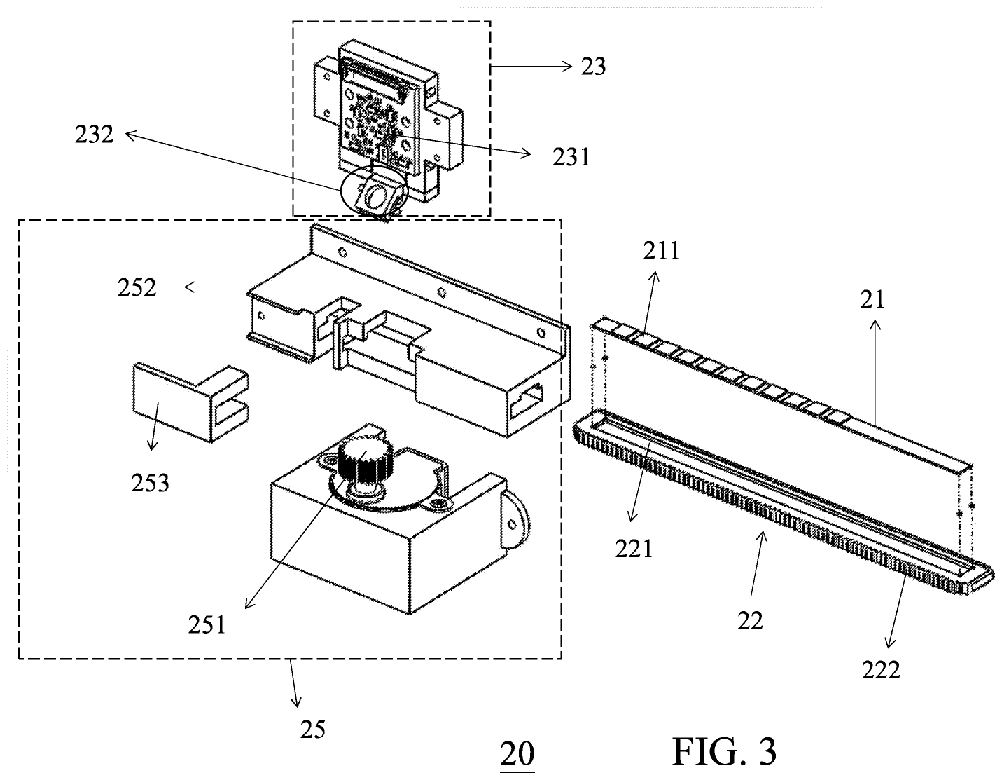

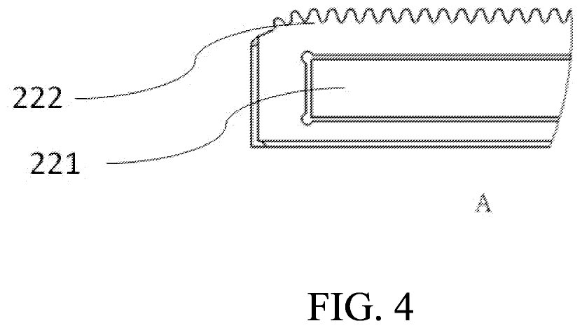

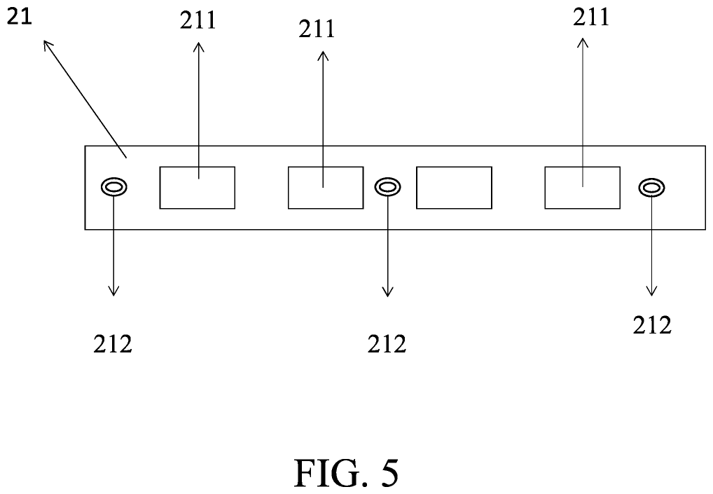

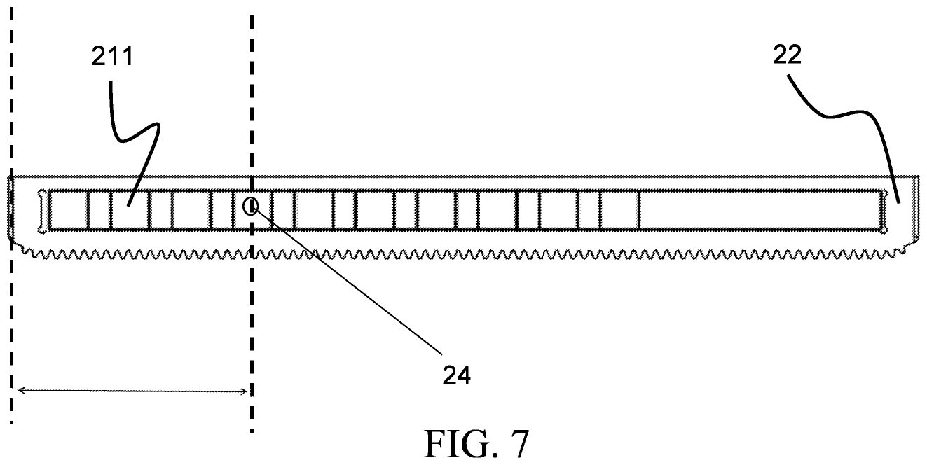

Referring to FIGS. 2 to 5, a 3D structural view of the screening test paper reading system, a structural breakdown view of the screening test paper reading system, a partial enlargement view of the test paper carrier, and a schematic view of the screening test paper according to the present invention are disclosed respectively. As shown in FIG. 2, the screening test paper reading system 20 of the invention comprises a screening test paper 21, a test paper carrier 22, a reading detection and light illumination unit 23, and a delivery unit 25. Also shown in FIG. 3, the screening test paper 21 is provided with a plurality of reaction zones 211 thereon for reacting with a plurality of specific samples (e.g., urine, blood, and etc.), and changing its own color accordingly. The test paper carrier 22 is provided with a bearing groove 221 thereon for accommodating the screening test paper 21, and the screening test paper 21 is fixed on the test paper carrier 22. In addition, the test paper carrier 22 is provided with a linking member 222 (may be a rack, wherein its two ends are in circular-arc-shape), and as shown in FIG. 4, the delivery unit 25 has a driving device 251 and a carrier base 252. When the driving device 251 (may be a stepper motor) detects the test paper carrier 22 has been placed onto the carrier base 252 in the delivery unit 25, the driving device 251 (the stepper motor) is activated and the test paper carrier 22 may be moved to a corresponding position by the linking member 222 (namely, the rack 222 will move forward or backward mechanically along with the stepper motor 251); when the test paper carrier 22 moves to a reading detection position of the reading detection and light illumination unit 23, the light illumination device 232 will emit light source and reflects on the screening test paper 21, so that the reading detection device 231 will read the reflected spectrum that has been reflected by the emitted light source on reaction zone 211 of the screening test paper 21, thereby enabling the reading detection device 231 to further retrieve spectrum signals from each reaction zone 211 on the screening test paper 21 for computing and analyzing the retrieved spectrum signals. In the above embodiment, the particular specimens comprise saliva, urine, blood, excrement, water, food, toxic and hazardous substance or microorganism. In another embodiment, a plurality of positioning parts 212 have been further arranged on the screening test paper 21, wherein the positioning parts 212 are provided to the reading detection and light illumination unit 23 for the use of detecting fine-tune and positioning (as shown in FIG. 5) in the reaction zone 211 on the screening test paper 21. The reading detection device 231 will first detect and read the positioning parts 212 on the screening test paper 21, so as to read and detect each reaction zone 211 and positioning parts 212 on the screening test paper 21 for position determination calculation (as shown in embodiment in FIG. 7). The light illumination device 232 disclosed above may be white LEDs, UV LEDs, NIR LEDs, laser diodes, halogen lamps or tungsten lamps. The reading detection device 231 may be an optical wavelength spectrometer or a spectrum analyzer.

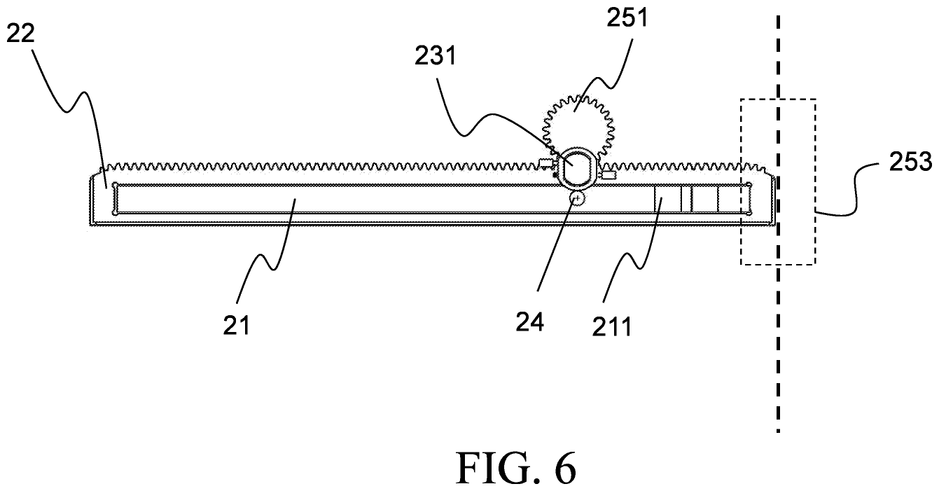

Additionally, another embodiment discloses a screening test paper reading system 10, wherein a delivery unit 25 is further arranged with a caging device 253, which is used for locating a relative position between the test paper carrier 22 and the reading detection device 231; when the test paper carrier 22 is inserted into a certain depth to the carrier base 252, the screening test paper reading system 20 will detect an insertion of the screening test paper 21 which requires a screening operation, and the driving device 251 of the delivery unit 25 will be automatically activated and move mechanically the test paper carrier 22 to a corresponding reading detection location, when the test paper carrier 22 moves to the caging device 253 (as shown in dashed), the reading detection device 231 will detect and verify an edge position between the caging device 253 and the test paper carrier 22, and also determine a first benchmark positioning (e.g. when the edge of the test paper carrier 22 moves to a dashed location). As shown in FIG. 6, the reading detection device 231 will read the position and calculate and locate a relative position between the caging device 253 and the test paper carrier 22. In the meantime, a spectrum reading point 24 and the positioning location of the reading detection device 231 will also be verified, so that the reading detection device 231 will retrieve spectrum signals from each reaction zone 211 subsequently once positioned. In addition, the caging device 253 disclosed in the above embodiment is used for preventing the test paper carrier 22 from shifting when the test paper carrier 22 is moved or being detached from the driving device 251 and the carrier base 252, and when the test paper carrier 22 is placed into the carrier base 252 in the delivery unit 25, the test paper carrier 22 moves with limited access to a “a squared C” form opening in the casing device 253, so as to achieve aforementioned purposes. The “a squared C” form opening of the caging device 253 may be replaced with a regular/round “C” or “L” form opening.

In terms of determining the urine glucose levels of a patient, a screening test paper specifically for urine glucose can be directly used to determine the level. The urine to be determined contacts with a reaction zone 211 of the screening test paper 21 (usually in a form of drip or infiltration), and the component in the reaction zone 211 reacts with the urine to be determined and changes its color accordingly. In addition, the reaction zone 211 may contain a variety of inspection zones to inspect glucose, protein, pH value, latent blood value or other physiological values in urine, thereby achieving a multiple inspection with one screening. After the urine to be determined contacts and reacts with the reaction zone 211 of the screening test paper 21, the screening test paper 21 may be provided in the bearing groove 221 of the test paper carrier 22, and the test paper carrier 22 is inserted into a spectrum analyzer (i.e., the screening test paper reading system 20 of the invention).

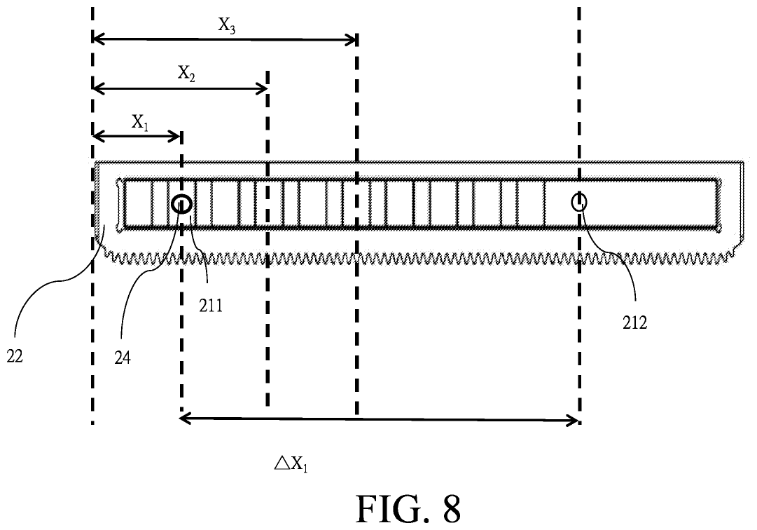

When the test paper carrier 22 is inserted to a certain depth of the carrier base 252, the reading detection and light illumination unit 23 may detect a plurality of positioning parts 222 on the test paper carrier 22 (shown as dotted appearance on the screening test paper in FIG. 8). At this time the screening test paper reading system 20 of the invention will determine that there is a screening test paper insertion which requires a screening operation. Therefore, the driving device 251 in the delivery unit will 25 automatically be activated, (generally speaking, the test paper carrier 22 is sucked into, wherein the driving device 251 may be a stepper motor, and move the test paper carrier 22 to a corresponding position through a mechanical action brought ab out by the linking member 222 and driving device 251. Then, the light illumination device 232 will emit light source to the screening test paper 21, and the reading detection device 231 will read the reflected spectrum reflected by the emitted light source from the reaction zone 211 on the screening test paper 21.) Notably, when the test paper carrier 22 moves to the caging device 253, as the distance position between the test paper carrier 22 moved by the driving device 251 and each reaction zone 211 of the screening test paper 21 as well as the relative position between the caging device 253 and the reading detection device 231 are all fixed or pre-determined in program parameters, which are as shown in FIG. 7, the reading detection device 231 will detect and verify an edge position between the caging device 253 and the test paper carrier 22, and also determine a first benchmark positioning as disclosed above. Therefore, when the edge of the test paper carrier 22 is benchmark positioned, the spectrum reading point 24 and the positioning location of the reading detection device 231 are also verified.

The reading position method disclosed in the screening test paper reading system is shown in FIG. 8. When the edge of the test paper carrier 22 is benchmark positioned, the spectrum reading point 24 and the positioning location of the reading detection device 231 are also verified. Furthermore, the distance position X1 between the border edge of the test paper carrier 22 and the reaction zone 211 and the relative distance position ΔX1 between the reaction zone 211 and the positioning part 212 are shown in the above embodiment. When the reading detection and light illumination unit 23 reads and detects the position, the relative distance position between each reaction zone 211 on the screening test paper and the positioning part 212 is able to provide the reading detection and light illumination unit 23 to adjust its determination operation. Therefore, the test paper carrier 22 moves to the reading detection device 231 to retrieve spectrum signals form each reaction zone 211 with high accuracy in terms of the relative position; hence, it enables a positioning at one time. Subsequently, the reading detection device 231 retrieves reflected spectrum from each reaction zone 211, and then conducts splitting processing and spectrum signal calculation in order to achieve a rapid screening goal in using the screening test paper.

Moreover, because the screening test paper 21 is completely fixed once placed into the bearing groove 221 without being directly contacted with the spectrum analyzer, the screening test paper 21 is not easily damaged under the protection of the test paper carrier 22, and the users are able to quickly replace a screening test paper from the test paper carrier 22 which achieves a goal for repetitive screening.

It is to be understood by those of ordinary skill in the art that the above preferable embodiments of the invention are described in detail and the various possible modifications and alterations of the embodiments could be made, without departing from the scope and spirit of the invention. The various embodiments such as “caging” are not limited by the way carrying out the embodiments in the specification.

What is claimed is:

1. A screening test paper reading system, comprising:
a reading detection and light illumination unit having a reading detection device and a light illumination device;
a screening test paper having a reaction zone arranged thereon, wherein the reaction zone reacts chemically with a number of particular specimens and changes color accordingly;
a test paper carrier having a bearing groove arranged thereon, which is for accommodating the screening test paper and fixing the screening test paper on the test paper carrier, and a linking member also arranged thereon as well; and
a delivery unit having a driving device and a carrier base, wherein when the test paper carrier is placed into the carrier base in the delivery unit, the driving device will be activated and the test paper carrier will be moved through the linking member, and when the test paper carrier moves to a reading detection position on the reading detection and light illumination unit, the light illumination device will emit light source to the screening test paper, and the reading detection device will read the reflected spectrum from the reaction zone on the screening test paper, so as to enable the reading detection device to retrieve spectrum signals from each reaction zone for conducting spectrum signal calculation and analysis.

2. The screening test paper reading system, as recited in claim 1, wherein the delivery unit further comprises a caging device, adapted for locating a relative position between the test paper carrier and the reading detection device.

3. The screening test paper reading system, as recited in claim 1, wherein the driving device is a stepper motor.

4. The screening test paper reading system, as recited in claim 1, wherein the linking member is a rack.

5. The screening test paper reading system, as recited in claim 1, wherein the screening test paper is for particular specimens selected from the group consisting of saliva, urine, blood, excrement, water, food, toxic and hazardous substance, microorganism, and combinations thereof.

6. The screening test paper reading system, as recited in claim 1, wherein the light illumination device is selected from the group consisting of white LEDs, UV LEDs, NIR LEDs, laser diodes, halogen lamps, tungsten lamps, and combinations thereof.

7. The screening test paper reading system, as recited in claim 1, wherein the reading detection device is an optical wavelength spectrometer or a spectrum analyzer.

8. The screening test paper reading system, as recited in claim 1, wherein the screening test paper further comprises a positioning part for the use of fine-tune positioning operated by the reading detection and light illumination unit.

9. The screening test paper reading system, as recited in claim 2, wherein the caging device further includes an opening with a “C”, “squared C” or “L” form to limit a position of the test paper carrier when it is moved, so that the test paper carrier will not shift or detach from its base.

10. The screening test paper reading system, as recited in claim 4, wherein two ends of the rack are in circular-arc-shape.
